(19) United States
(12) Patent Application Publication
(10) Pub. No.: US 2004/0002248 A1
(43) Pub. Date: Jan. 1, 2004

(54) Filtered electrical connector

(75) Inventors: Micheal Glick, Farmington Hills, MI (US); William R. Lyons, Southfield, MI (US)

Correspondence Address: HARRINGTON & SMITH, LLP, 4 RESEARCH DRIVE, SHELTON, CT, 06484-6212, US

(73) Assignee: FCI Americas Technology, Inc.

(21) Appl. No.: 10/184,324

(22) Filed: Jun. 26, 2002

(51) Int. Cl. H01R 13/627

(52) U.S. Cl. 439/352

(57) ABSTRACT

An electrical filter connector terminal for being received, at least partially, in a ferrite hood. The terminal including a first connection section; a second female connection section; and a positioning section located between the first and second connection sections. The positioning section is aligned in a column with the second female connection section. The positioning section comprises an outer perimeter which is at least partially larger than an outer perimeter of the second female connection section. A first edge of the positioning section can contact a rear edge of a ferrite hood positioned onto the second female connection section. At least a portion of the outer perimeter of, the positioning section can contact an interior wall of a contact receiving hole of a connector housing for aligning the second female connection section in the contact receiving hole.

### BACKGROUND OF THE INVENTION

1. Field of the Invention

The present invention relates to electrical connectors and, more particularly, to filtered electrical connectors having ferrite members.

2. Brief Description of Prior Developments

U.S. Pat. No. 5,489,220 discloses a filter connector with a ferrite barrel for two electrical contacts. U.S. Pat. No. 5,213,522 discloses a filtered connector with a multi-piece ferrite block. A problem with these types of ferrite blocks is that they must be made of electrically non-conductive ferrite oxide to prevent short-circuiting of the contacts and, therefore, cannot filter lower frequencies (about 1≦50 MHz) without increasing length of the ferrite block and thereby increasing the size of the connector. For a filtered connector intended to be used in a small space, such as an air bag connector, increasing the size of the connector is not desired. If an electrically conductive ferrite oxide material needed to be used for lower frequency attenuation, such as about 1-150 MHz, electrical insulators would need to be added between the contacts and the ferrite block.

U.S. Pat. No. 6,152,775, which is hereby incorporated by reference in its entirety, discloses a filtered electrical connector with multiple ferrite members. In the embodiment shown in FIG. 4, the contact has a stop surface for contacting a rear end of the ferrite hood. The connector overcomes the problems noted above with regard to U.S. Pat. Nos. 5,489,220 and 5,213,522, but centering of the female contact section in the housing is controlled by the ferrite hood; which is not a precise positioning system. There is a desire to provide a connector which comprises a ferrite hood over a female connection section of a contact, but which has a more accurate and repeatable contact positioning system.

In one type of conventional right-angle air bag filtered electrical connector, there is a 90° bend or transition in the contact between the barrel of the contact and the lead portion of the contact. The transition has a cross-sectional curved shape. The positioning stop of the ferrite tube on the contact was the bottom surface of the lead portion. Thus, the compound curvature at the bent transition was located inside the ferrite tube. This widened, compound curved transition required that the interior aperture of the ferrite tube be slightly larger than the barrel section of the contact. This was because a clearance was needed. The material of the ferrite tube is relatively fragile compared to the metal contact. If the clearance was not provided the contact could damage the ferrite by causing it to crack. This clearance caused a floating problem of the contact relative with the ferrite tube. Hence, this caused an alignment problem when attempting to connect the connector to a mating connector. Misalignment could cause damage to the contacts. The present invention helps to reduce damage to the connector by reducing misalignment problems. There is a desire to provide better engagement and alignment than prior art air bag connectors. There is also a desire to remove the tolerances factor of the ferrite hood from the alignment and engagement precision of the connector with a mating connector.

### SUMMARY OF THE INVENTION

In accordance with one aspect of the present invention, an electrical filter connector terminal is provided for being received, at least partially, in a ferrite hood. The terminal including a first connection section; a second female connection section; and a positioning section located between the first and second connection sections. The positioning section is aligned in a column with the second female connection section. The positioning section comprises an outer perimeter which is at least partially larger than an outer perimeter of the second female connection section. A first edge of the positioning section can contact a rear edge of a ferrite hood positioned onto the second female connection section. At least a portion of the outer perimeter of the positioning section can contact an interior wall of a contact receiving hole of a connector housing for aligning the second female connection section in the contact receiving hole.

In accordance with another aspect of the present invention, an electrical filter connector assembly is provided comprising a housing, electrical contact terminals, and at least one ferrite hood. The housing is adapted to be plugged into a socket of a gas generator. The housing comprises at least one contact receiving hole. The electrical contact terminals have a wire connection section, a female connection section, and a terminal positioning section. The terminals are located in the at least one contact receiving hole. The at least one ferrite hood is mounted on the female connection sections of the terminals. The terminal positioning sections of the terminals contact the housing in the at least one contact receiving hole to align the female connection sections of the terminals relative to the at least one contact receiving hole.

In accordance with another aspect of the present invention, an electrical filter connector assembly is provided comprising a housing, electrical contact terminals, and at least one ferrite hood. The housing is adapted to be plugged into a socket of a gas generator. The housing comprises at least one contact receiving hole. The electrical contact terminals have a wire connection section, a female connection section, and a terminal positioning section. The terminals are located in the at least one contact receiving hole. The at least one ferrite hood is mounted on the female connection sections of the terminals. The terminal positioning sections of the terminals have a general tubular shape. The general tubular shapes are each aligned behind one of the female connection sections and have an edge adapted to contact a rear end of the at least one ferrite hood.

### BRIEF DESCRIPTION OF THE DRAWINGS

The foregoing aspects and other features of the present invention are explained in the following description, taken in connection with the accompanying drawings, wherein:

FIG. 1 is a perspective view of an electrical connector incorporating features of the present invention attached to an air bag gas generator;

FIG. 2 is an exploded perspective view of the electrical connector shown in FIG. 1;

FIG. 3 is a cross-sectional view of the electrical connector shown in FIG. 1;

FIG. 4 is an exploded perspective view of one of the electrical contact terminals and ferrite hoods of the connector shown in FIGS. 2-3; and

FIG. 5 is a perspective view of the electrical contact terminal and ferrite hood shown in FIG. 4, with a cutaway section of the ferrite hood and a cut-away section of a portion of one of the cantilevered arms of the positioning section of the terminal, which are shown in an assembled position.

### DESCRIPTION OF THE PREFERRED EMBODIMENT

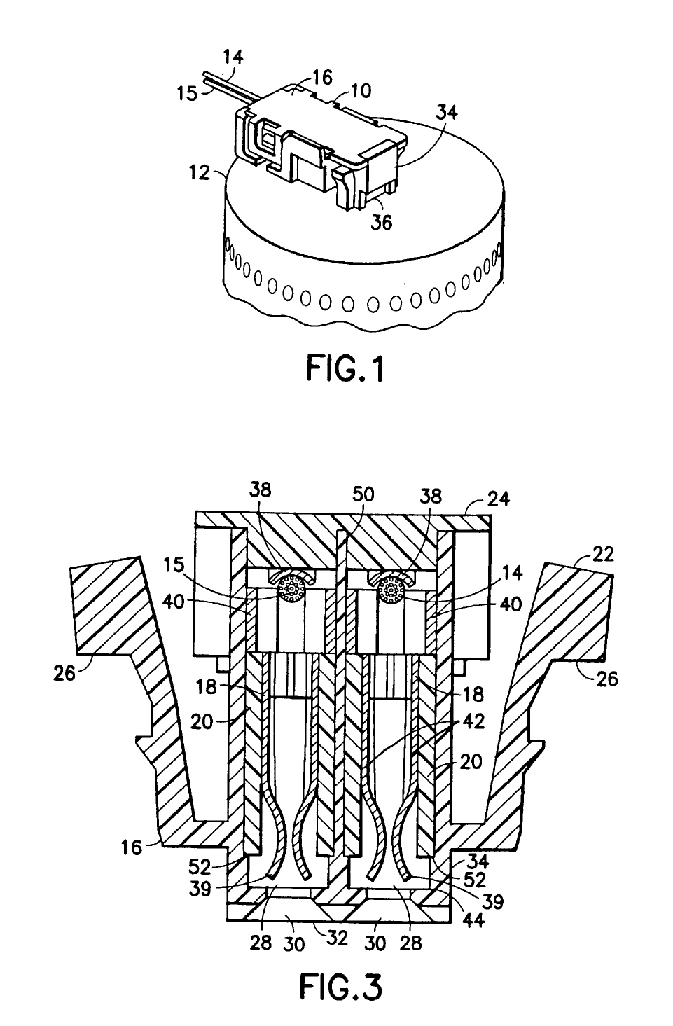

Referring to FIG. 1, there is shown a perspective view of an electrical connector 10, incorporating features of the present invention, shown attached to an air bag gas generator 12. In alternate embodiments, the connector 10 could be attached to any suitable type of gas generator or, to any other type of electrical or electronic component. Although the present invention will be described with reference to the exemplary embodiment shown in the drawings, it should be understood that the present invention can be embodied in many alternate forms of embodiments. In addition, any suitable size, shape or type of elements or materials could be used.

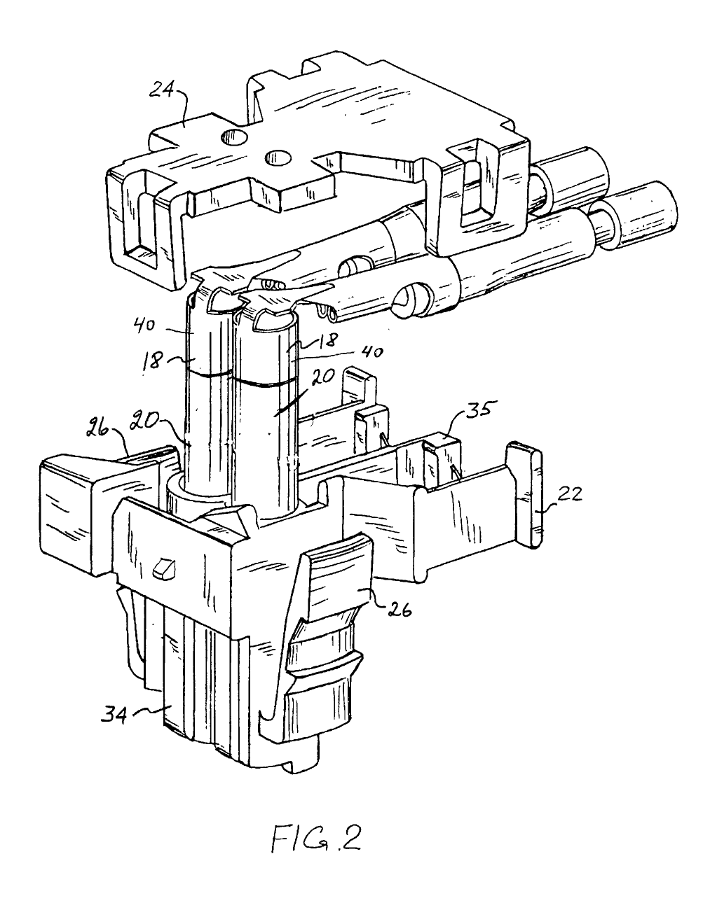

The connector 10, in this embodiment, is for use in connecting electrical conductors 14, 15 with the air bag gas generator 12. Referring also to FIGS. 2 and 3, the connector 10 generally comprises a housing 16, electrical contact terminals 18 and ferrite hoods 20. The housing 16 comprises a first housing piece 22 and a second housing piece 24. The two housing pieces are preferably comprised of molded plastic or polymer material. However, in alternate embodiments, any suitable material(s) could be used. In an alternate embodiment, the housing could be comprised of more or less than two housing pieces.

The first housing piece 22 includes two cantilevered finger actuatable deflectable latches 26, two separate receiving areas 28, and two holes 30 through a bottom face 32 of the housing into the receiving areas 28. However, in alternate embodiments, the latches 26 might not be provided. Alternatively, any suitable type of latching system could be provided. The housing 16, at the bottom of the front section 34, is adapted to be plugged into a socket 36 of the gas generator 12. The latches 26 are adapted to latch with latch surfaces in the socket 36. optionally, additional connector position assurance means (not shown) can be provided to prevent the connector 10 from accidentally being disengaged from the gas generator 12. The second housing piece 24 is preferably snap lock mounted onto the first housing piece 22 after the contacts 18 and ferrite hoods 20 are located in the receiving areas 28. However, in alternate embodiments, any suitable type of connection could be provided. In addition, in alternate embodiments, other types of housings or housing components could be provided.

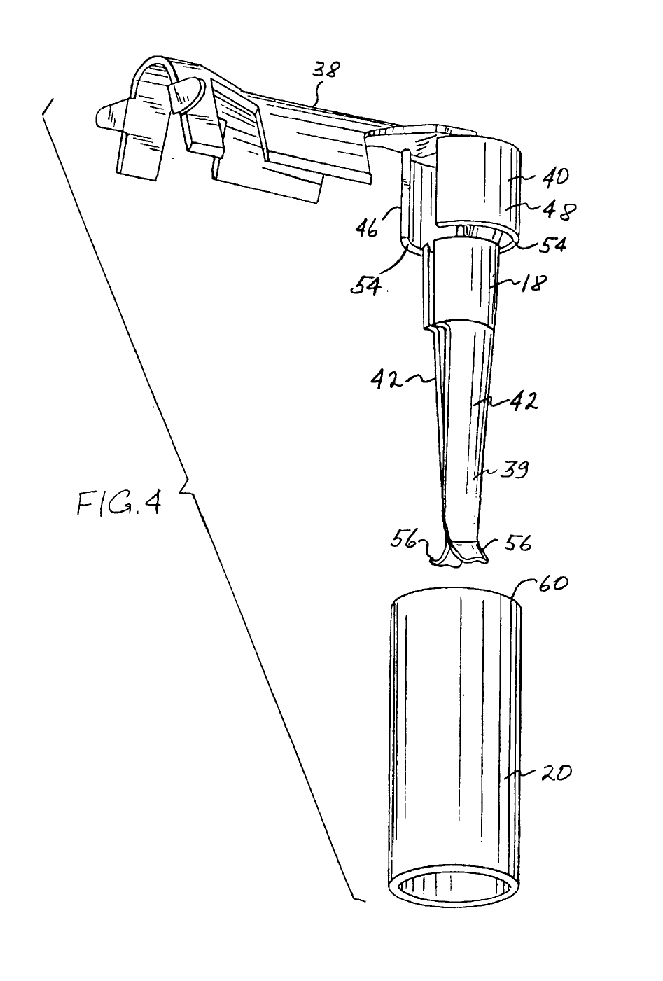

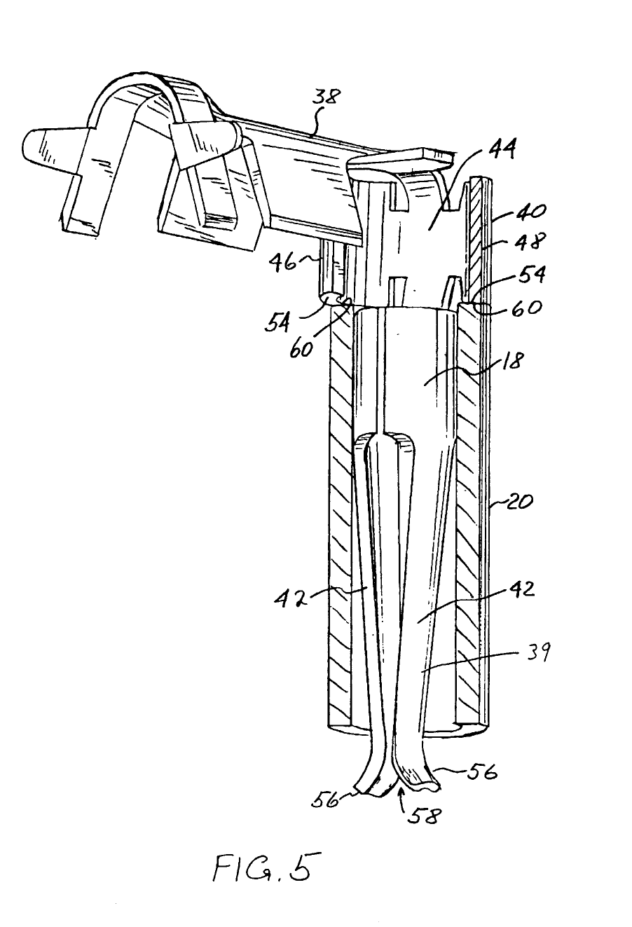

Referring also to FIGS. 4 and 5, the electrical contact terminals 18 each comprise a first connection section 38, a second female connection section 39, a positioning section 40. However, in alternate embodiments, the terminals 18 could comprise additional sections or sections which are shaped differently from the shapes of shown in the drawings. Preferably, the contact terminals 18 are comprised of stamped and formed sheet metal. However, in alternate embodiments, the contact terminals could be comprised of any suitable material(s) and/or could be formed by any suitable contact manufacturing process.

The first connection section 38 is provided for forming a lead section for the contact terminal 18. The first connection section 38 can be crimped onto one of the electrical conductors 14, 15 for connecting the electrical conductors 14, 15 to the contact terminal 18. However, in alternate embodiments, the first connection section 38 could have any suitable shape. The conductors 14, 15 could be crimped, soldered or welded to the first connection section 38. In the embodiment shown, the first connection section 38 is angled about 90° relative to the second connection section 39. However, the lead section could be straight for an in-line connector.

The positioning section 40 is located between the first connection section 38 and the second connection section 39. In the embodiment shown, the positioning section 40 generally comprises a main shaft section 44 and two cantilevered arms 46, 48. In an alternate embodiment, the positioning section could comprise additional or alternative sections. For example, the positioning section 40 could comprise more or less than two cantilevered arms. As another example, the cantilevered arm(s) could be cantilevered in a downward direction rather than a lateral direction from the main shaft section.

The main shaft section 44 connects the first connection section 38 to the second connection section 39. The two cantilevered arms 46, 48 extend from opposite sides of the main shaft section 44. In the embodiment shown, the two cantilevered arms 46, 48 are substantially mirror images of each other. However, in alternate embodiments, the two cantilevered arms could comprise different sizes and shapes. Each cantilevered arm comprises a general curved shape. The cantilevered arms 46, 48 extend outwardly from the main shaft section 44 and curved inwardly towards each other. This forms the positioning section 40 with a general tubular shape. However, in alternate embodiments, the positioning section 40 could comprise any suitable type of shape.

The positioning section 40 is sized and shaped to be received in the upper part of one of the receiving areas 28. The outer surfaces of the cantilevered arms 46, 48 make a direct physical contact with the inner walls of the first housing piece 22 in the upper part of the receiving area 28. In a preferred embodiment, the positioning section 40 has its outer surfaces of the cantilevered arms 46, 48 make a mating friction fit engagement with the inner walls of the receiving area 28. If desired, when the cantilevered arms 46, 48 are inserted into the receiving area 28, they can resiliently deflect inward to form a press fit mating of the positioning section 40 with the first housing piece 22.

The cantilevered arms 46, 48 have a height which allows the positioning section 40 to center the positioning section 40 and second connection section 39 in the receiving area 28. The cantilevered arms 46, 48 form an outer perimeter which is larger than the outer perimeter of the second connection section 39. The cantilevered arms 46, 48 form contact surfaces 54 on their bottom edges. The contact surfaces 54 are located laterally outward past the outer sides of the second connection section 39.

In the embodiment shown, the second female connection section 39. generally comprises two spring contact arms 42. However, in alternate embodiments, the second female connection section could comprise more than two spring contact arms or, alternatively, could comprise any suitable type of female shaped connection section. The two spring contact arms 42 extend in a general cantilever fashion from the main shaft section 44 of the positioning section 40. In the embodiment shown, each spring contact arms 42 comprises a general curved cross-section and are substantially mirror images of each other. Thus, the second connection section 39 forms a general column shape. However, in alternate embodiments, the contact arms could have different shapes and/or could be different from each other.

In the embodiment shown, the general tubular shape of the positioning section 40 is coaxially aligned with the center axis of the second connection section 39. However, in alternate embodiments, the positioning section and the second connection section need not be coaxially aligned. The two spring contact arms 42 taper towards each other towards their distal ends 56. The distal ends 56 flair outward to form a male contact entrance area 58. However, as noted above, in alternate embodiments the spring contact arms could comprise any suitable type of shape.

In the embodiment shown, the second connection section 39 has a longer length than the ferrite hood 20. However, in an alternate embodiment, the second connection section might not be longer than the ferrite hood. The second connection section 39 is sized and shaped to be inserted into the ferrite hood 20. In a preferred embodiment, the top portion of the second connection section 39 makes a friction fit with the inside wall of the ferrite hood 20. When the ferrite hood 20 is located on the contact terminal 18, the distal ends 56 of the spring contact arms 42 extend outward past the bottom end of the ferrite hood 20.

The ferrite hoods 20 are provided as two separate members; one for each contact terminal 18. However, in an alternate embodiment, the connector might only comprise one ferrite hood. In a preferred embodiment the ferrite hoods 20 have tube shapes and are comprised of the same material, such as electrically conductive ferrite oxide. However, the hoods could have different shapes, could be comprised of electrically non-conductive ferrite oxide, and/or the hoods could be made of differing materials; such as one hood being made of electrically conductive ferrite oxide and the other hood being made of electrically non-conductive ferrite oxide.

In the embodiment shown, the two receiving areas 28 are separated by a wall 50 of the housing 16. The receiving areas 28 have shelves 52 above the holes 30 that allow the bottom edges of the ferrite hoods 20 to be positioned against. The ferrite hoods 20 are matingly received in the separate receiving areas 28. In an alternate embodiment, the first housing piece 22 might not comprise the wall 50, and the two ferrite hoods 20 could physically contact each other.

The socket 36 of the gas generator 12 shown in FIG. 1 has two male pin contacts (not shown) at a fixed spacing relative to each other that are received in the two female connection sections 39 through the holes 30 in the housing 12. Thus, the contact terminals 18 are able to electrically connect the male pin contacts (not shown) to the conductors 14, 15.

When the contact terminals 18 are connected to the conductors 14, 15, the hoods 20 placed on the contact terminals 18, and the hoods and terminals placed in the first housing piece 22, the second housing piece 24 is then snap lock mounted onto the first housing piece 22 to capture the terminals and hoods in place at a fixed relationship to each other. The first and second housing pieces 22, 24 also provide strain relief for the, conductors 14, 15 at the rear section 35. In an alternate embodiment the strain relief might not be provided, or could be provided by an over-molded third housing piece (not shown) or any other suitable means.

By providing each terminal 18 with its own separate and spaced ferrite hood 20, the hoods 20 can now be comprised of electrically conductor ferrite oxide, such that certain frequencies can be attenuated which otherwise could not be attenuated with electrically non-conductive ferrite oxide. The shapes of the hoods 20 are optimized for maximum efficiency such that excess ferrite oxide material is not used. Compared to the ferrite block in U.S. Pat. No. 5,489,220, about 75 percent less ferrite material can be used. This can obviously reduce the size of the overall connector. Thus, cost and weight and size of the connector can be minimized.

The embodiment shown can allow two different ferrite oxide materials to be used in the same connector, such is one for high frequency attenuation and one for low frequency attenuation for a better or wider range of filtering. Even though the ferrite hoods 20 can be made of electrically conductive material, they can still be mounted directly on the terminals 18 without use of an insulator between the two ferrite members because the two ferrite hoods 20 are electrically separated from each other. When attempting to reduce the size of a filter connector using a ferrite block by making the ferrite block smaller more filtering problems would be expected to be encountered. The embodiment shown can provide a means to reduce the size of the connector while maintaining good filtering by providing separate hoods for each contact and by optimizing the length and width of each hood 20 for the best filtering without unnecessary ferrite oxide material.

A direct mechanical connection between the terminals 18 and hoods 20 also makes assembly easier and less expensive regardless of whether the hoods 20 are comprised of electrically conductive or non-conductive material. The present invention can also be combined with a coil filter in the connector if desired, and is preferably used with a shorting bar in the socket 36.

Preferably, the hoods 20 are comprised of metal powder which is pressed into a mold and sintered into shape.

Alternative manufacturing, such as extrusion could also be used. If the housing allows for servicing by opening or removing the housing, the terminals can be reused by merely disconnecting the hoods 20 from the terminals 18 and attaching new ferrite hoods. Thus, the connector 10 is serviceable after the gas generator 12 is used.

The female connection sections 39 are received inside respective ones of the hoods 20. When the contact terminals 18 are inserted into the hoods 20, a top surface 60 of the ferrite hood 20 contacts the contact surfaces 54 of the cantilevered arms 46, 48 of the positioning section 40. The positioning section 40 functions as a stop for locating the ferrite hood 20 at a predetermined longitudinally position on the second connection section 39. Thus, the positioning section 40 can be used to perform two different positioning or locating functions. The positioning section 40 can directly align the second connection section 39 with the receiving area 28 of the housing 16. Thus, the embodiment described above can provide to the feature of centering the terminal using the plastic housing 16 rather than using the ferrite hood 20. The plastic housing 16 can be molded with greater precision than the forming of the ferrite hood 20. Thus, manufacturing tolerances of the assembly can be improved. In addition, the positioning section 40 can longitudinally position the ferrite hood 20 at a predetermined axial position relative to the second connection section 39.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. An electrical filter connector terminal for being received, at least partially, in a ferrite hood, the terminal comprising:
a first connection section;
a second female connection section; and
a positioning section located between the first and second connection sections,
wherein, the positioning section is aligned in a column with the second female connection section, and wherein the positioning section comprises an outer perimeter which is at least partially larger than an outer perimeter of the second female connection section such that a first edge of the positioning section can contact a rear edge of a ferrite hood positioned onto the second female connection section and, such that at least a portion of the outer perimeter of the positioning section can contact an interior wall of a contact receiving hole of a connector housing for aligning the second female connection section in the contact receiving hole.

2. An electrical filter connector terminal as in claim 1 wherein the first connection section comprises a wire connection section.

3. An electrical filter connector terminal as in claim 1 wherein the first connection section is angled at a general right angle relative to the second female connection section.

4. An electrical filter connector terminal as in claim 1 wherein the terminal is comprised of a one-piece member formed from stamped and formed sheet metal.

5. An electrical filter connector terminal as in claim 1 wherein the positioning section comprises a general tubular shape formed by at least one cantilevered curved arm.

6. An electrical filter connector terminal as in claim 5 wherein the at least one cantilevered curved arm comprises two of the cantilevered curved arms which curve outward and then inward towards each other.

7. An electrical filter connector terminal as in claim 1 wherein the second female connection section comprises a general tubular shape formed by at least one cantilevered curved arm.

8. An electrical filter connector terminal as in claim 7 wherein the at least one cantilevered curved arm comprises two of the cantilevered curved arms, the two cantilevered curved arms being substantial mirror images of each other.

9. An electrical filter connector assembly comprising:
a housing adapted to be plugged into a socket of a gas generator, the housing comprising at least one contact receiving hole;
a plurality of electrical contact terminals located in the housing, the plurality of electrical contact terminals comprising the electrical filter connector terminal as in claim 1; and
at least one ferrite hood mounted on the female connection section of the electrical filter connector terminal.

10. An electrical filter connector assembly comprising:
a housing adapted to be plugged into a socket of a gas generator, the housing comprising at least one contact receiving hole;
electrical contact terminals having a wire connection section, a female connection section, and a terminal positioning section, the terminals being located in the at least one contact receiving hole; and
at least one ferrite hood mounted on the female connection sections of the terminals,
wherein the terminal positioning sections of the terminals contact the housing in the at least one contact receiving hole to align the female connection sections of the terminals relative to the at least one contact receiving hole.

11. An electrical filter connector assembly as in claim 10 wherein the housing is comprised of a molded polymer material.

12. An electrical filter connector assembly as in claim 10 wherein the terminal positioning sections form a friction fit between the terminals and the housing in the contact receiving holes.

13. An electrical filter connector assembly as in claim 10 wherein the wire connection section is angled at a general right angle relative to the female connection section.

14. An electrical filter connector assembly as in claim 10 wherein the terminals are each comprised of a one-piece member formed from stamped and formed sheet metal.

15. An electrical filter connector assembly as in claim 10 wherein the positioning sections each comprise a general tubular shape formed by at least one cantilevered curved arm.

16. An electrical filter connector assembly as in claim 15 wherein each terminal comprises two of the cantilevered curved arms which curve outward and then inward towards each other.

17. An electrical filter connector assembly as in claim 10 wherein the second female connection sections each comprise a general tubular shape formed by at least one cantilevered curved arm.

18. An electrical filter connector assembly as in claim 17 wherein each terminal comprises two of the cantilevered curved arms, the two cantilevered curved arms being substantial mirror images of each other.

19. An electrical filter connector assembly comprising:
a housing adapted to be plugged into a socket of a gas generator, the housing comprising at least one contact receiving hole;
electrical contact terminals having a wire connection section, a female connection section, and a terminal positioning section, the terminals being located in the at least one contact receiving hole; and
at least one ferrite hood mounted on the female connection sections of the terminals,
wherein the terminal positioning sections of the terminals have a general tubular shape, and wherein the general tubular shapes are each aligned behind one of the female connection sections and have an edge adapted to contact a rear end of the at least one ferrite hood.

20. An electrical filter connector assembly as in claim 19 wherein the general tubular shape has an outer perimeter which is at least partially larger than an outer perimeter of the at least one ferrite hood, such that the outer perimeter of the general tubular shape contacts an interior wall of the housing in the contact receiving hole to align the female connection section in the contact receiving hole.
